(19) United States
(12) Patent Application Publication
(10) Pub. No.: US 2025/0148708 A1
(43) Pub. Date: May 8, 2025

(54) METHOD, DEVICE, AND SYSTEM FOR PROCESSING AND DISPLAYING ULTRA-REALISTIC VIDEO CONTENT AND STEREOSCOPIC IMAGES CAPABLE OF XR INTERACTION BETWEEN USERS

(71) Applicant: Electronics and Telecommunications Research Institute, Daejeon (KR)

(72) Inventors: Min Sung YOON, Daejeon (KR); Jong Sung KIM, Daejeon (KR)

(73) Assignee: Electronics and Telecommunications Research Institute, Daejeon (KR)

(21) Appl. No.: 18/936,146

(22) Filed: Nov. 4, 2024

(30) Foreign Application Priority Data
Nov. 8, 2023 (KR) 10-2023-0154016

(51) Int. Cl. G06T 17/00; G06V 10/44

(52) U.S. Cl. CPC G06T 17/00; G06V 10/44

(57) ABSTRACT

A method and device for generating and displaying interactive 3D content are disclosed. According to one embodiment of the present disclosure, a method of generating and displaying interactive 3D content performed by a device may include receiving sensing data on a user's body from at least one sensor attached to the user's body; obtaining feature data related to the user's body and movement based on the sensing data; obtaining a content level or difficulty matching the user by inputting feature data and 3D (dimension) content into an artificial intelligence (AI) model; setting a level or difficulty of the 3D content according to the obtained content level or difficulty; and uploading the 3D content to a display terminal worn by the user.

### CROSS-REFERENCE TO RELATED APPLICATIONS

This application claims the benefit of earlier filing date and right of priority to Korean Application No. 10-2023-0154016, filed on Nov. 8, 2023, the contents of which are all hereby incorporated by reference herein in their entirety.

### TECHNICAL FIELD

The present disclosure relates to an image processing technology that enables interaction between realistic image contents, and more specifically, to a method, device, and system that generates customized content according to a user's physical ability or cognitive ability and displays the same in real time to enable an experience of realistic image contents formed in a three-dimensional real space.

### BACKGROUND

With the recent development of augmented reality (AR)/virtual reality (VR)-based XR display technology or holographic AR display technology, interest in 3D augmented content technology and holographic 3D content technology that can express objects with perfect binocular parallax and depth is growing.

In particular, terminals that apply head-mounted holographic AR technology can relieve eye fatigue and dizziness caused by accommodation-convergence mismatch problems.

Holographic display technology is a technology that expresses objects three-dimensionally within a three-dimensional space, and can be used to display and process fully realistic three-dimensional images.

Specifically, holographic display technology can produce the same effect as if an object actually exists to the human eye by reproducing the wavefront generated by a given object.

Furthermore, holographic technology is evolving into the ultimate 3D display technology because it allows viewing natural images that resemble the real world as the viewpoint moves.

### SUMMARY

The technical problem of the present disclosure is to provide a method, device and system for generating 3D data suitable for a head-mounted (or face-worn) XR terminal or a holographic AR terminal.

The technical problem of the present disclosure is to provide a method, device and system for producing holographic AR/XR content capable of displaying a stereoscopic image that enables interaction between a user and a restored image.

The technical problem of the present disclosure is to provide a method, device and system for generating customized content according to a user's physical ability or cognitive ability and displaying the same in real time to enable the user to experience realistic image content formed in a three-dimensional real space.

The technical problems to be achieved in the present disclosure are not limited to the technical tasks mentioned above, and other technical problems not mentioned will be clearly understood by those skilled in the art from the description below.

According to one embodiment of the present disclosure, a method of generating and displaying interactive 3D content performed by a device may include receiving sensing data on a user's body from at least one sensor attached to the user's body; obtaining feature data related to the user's body and movement based on the sensing data; obtaining a content level or difficulty matching the user by inputting feature data and 3D (dimension) content into an artificial intelligence (AI) model; setting a level or difficulty of the 3D content according to the obtained content level or difficulty; and uploading the 3D content to a display terminal worn by the user.

In addition, the sensing data may include at least one of coordinates, velocity, acceleration, or angular velocity of a body part of the user, and the obtaining the feature data may comprise obtaining characteristic data including a level of physical ability of the user and a characteristics of the user's movement through at least one of the coordinates, velocity, acceleration, or angular velocity of a body part of the user.

In addition, the method may include obtaining a color image and a depth map for at least one object; and generating 3D data for the at least one object based on each of the color images and the depth map.

In addition, the method may include preprocessing 3D data for at least one object; generating at least one hologram data using the preprocessed 3D data for at least one object; and correcting the at least one hologram data based on information on the display terminal.

In addition, the information on the display terminal includes a size of the display terminal, a performance of the display terminal, a type of an operating device connected to the display terminal, and a type of the display terminal, and a size and arrangement of the at least one hologram data may be corrected based on the size of said display terminal, the performance of the display terminal, the type of at least one operating device connected to the display terminal, and the type of the display terminal.

In addition, the AI model is trained to output a content level or difficulty level that matches the user based on at least one of the corrected hologram data, the level of physical ability of the user, and the characteristics of the user's movements.

In addition, the display terminal may comprise a head mounted display, and the at least one operating device may comprise a wearable device capable of interacting with the at least one hologram data included in the 3D content.

According to one embodiment of the present disclosure, a device for generating and displaying interactive 3D content may include at least one memory; and at least one processor, and the at least one processor may be configured to: receive sensing data on a user's body from at least one sensor attached to the user's body; obtain feature data related to the user's body and movement based on the sensing data; obtain a content level or difficulty matching the user by inputting feature data and 3D (dimension) content into an artificial intelligence (AI) model; set a level or difficulty of the 3D content according to the obtained content level or difficulty; and upload the 3D content to a display terminal worn by the user.

In addition, the at least one processor may be configured to: obtain characteristic data including a level of physical ability of the user and a characteristics of the user's movement through at least one of the coordinates, velocity, acceleration, or angular velocity of a body part of the user.

In addition, the at least one processor may be configured to: obtain a color image and a depth map for at least one object; and generate 3D data for the at least one object based on each of the color images and the depth map.

In addition, the at least one processor is configured to: preprocess 3D data for at least one object; generate at least one hologram data using the preprocessed 3D data for at least one object; and correct the at least one hologram data based on information on the display terminal.

According to one embodiment of the present disclosure, a system for creating and displaying interactive 3D content may include a device; and a display terminal, and the device may be configured to: receive sensing data on a user's body from at least one sensor attached to the user's body; obtain feature data related to the user's body and movement based on the sensing data; obtain a content level or difficulty matching the user by inputting feature data and 3D (dimension) content into an artificial intelligence (AI) model; set a level or difficulty of the 3D content according to the obtained content level or difficulty; and upload the 3D content to a display terminal worn by the user, and the display terminal may be configured to: display the 3D content in a 3D space; and apply a user command input through at least one operating device to the 3D content.

According to one embodiment of the present disclosure, one or more non-transitory computer readable media storing one or more instructions, wherein the one or more instructions are executed by one or more processors to control a device for generating and displaying interactive 3D content to perform receiving sensing data on a user's body from at least one sensor attached to the user's body; obtaining feature data related to the user's body and movement based on the sensing data; obtaining a content level or difficulty matching the user by inputting feature data and 3D (dimension) content into an artificial intelligence (AI) model; setting a level or difficulty of the 3D content according to the obtained content level or difficulty; and uploading the 3D content to a display terminal worn by the user.

The features briefly summarized above with respect to the disclosure are merely exemplary aspects of the detailed description of the disclosure that follows, and do not limit the scope of the disclosure.

According to various embodiments of the present disclosure, a method, device and system for generating 3D data suitable for a head-mounted XR terminal or a holographic AR terminal can be provided.

According to various embodiments of the present disclosure, a method, device and system for producing holographic AR/XR content capable of displaying a stereoscopic image capable of interacting between a user and a restored image can be provided.

According to various embodiments of the present disclosure, a method, device, and system can be provided that generates customized content according to a user's physical ability or cognitive ability and displays the same in real time to enable an experience of realistic image content formed in a three-dimensional real space.

The effects obtainable in the present disclosure are not limited to the effects mentioned above, and other effects not mentioned will be clearly understood by those skilled in the art from the description below.

### BRIEF DESCRIPTION OF THE DRAWINGS

The accompanying drawings included as part of the detailed description to facilitate understanding of the present disclosure provide embodiments of the present disclosure and describe technical features of the present disclosure along with detailed descriptions.

FIG. 1 is a diagram illustrating components and processes for generating and displaying interactive holographic content according to one embodiment of the present disclosure.

FIG. 2 is a diagram illustrating the operation of a user action specific analysis unit according to one embodiment of the present disclosure.

FIG. 3A and FIG. 3B illustrate measurement results of PSNR from the learning process of the MHHD model described above according to an embodiment of the present disclosure.

FIG. 4A and FIG. 4B illustrate color images, depth maps, and holograms generated using them according to an embodiment of the present disclosure.

FIG. 5 is a diagram for explaining a process of a user wearing an XR device interacting with a 3D object according to an embodiment of the present disclosure.

FIG. 6A illustrates a process of rapidly generating/processing images of various viewpoints or images between viewpoints according to an embodiment of the present disclosure.

FIG. 6B illustrates a process of real-time interaction between a wearer of an XR device and a reproduced holographic AR/XR image according to an embodiment of the present disclosure.

FIG. 7 is a flowchart for explaining a method of generating and displaying interactive holographic content according to an embodiment of the present disclosure.

FIG. 8 is a block diagram illustrating a device according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In this disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

The system and/or method/device (hereinafter simply referred to as the ‘system’) proposed in the present disclosure relates to a technology for processing and displaying hyper-realistic image content and stereoscopic images capable of XR interaction between users.

Specifically, the present disclosure relates to a method, device, and system for processing stereoscopic images capable of real-time interaction while providing a customized content generation function according to a user's physical or cognitive abilities in a head mounted display (HMD) XR terminal or a holographic AR terminal.

That is, the present disclosure relates to a method, device and system for acquiring CG or real-life-based 3D data and displaying realistic image content.

Devices that can be linked to a head-mounted XR terminal or a holographic AR terminal can be configured so that the user can easily hold it in his or her hand or attach it to the user's body.

For example, devices that can be linked to head-mounted XR terminals or holographic AR terminals can be lightweight and configured as wearable devices.

The present disclosure may include a method for providing an interaction function between a user and a terminal for restoring a holographic AR/XR image based on 3D image information of a 360-degree multi-viewpoint, and at the same time, a deep learning method for easily producing content for holography at high speed.

In particular, a method for generating holographic content and processing images that enables interaction between a user and a restored realistic image according to one embodiment of the present disclosure is suitable for personal portable mobile applications while providing immersive and 3D realistic effects to viewers.

Hereinafter, a method for providing customized content based on a user's physical or cognitive abilities is described.

In describing the present disclosure, the term “device” may collectively refer to a device that processes and displays hyper-realistic video content and stereoscopic images that enable XR interaction between users. In other words, the term “device” may collectively refer to one or more devices that constitute a system that processes and displays hyper-realistic video content and stereoscopic images that enable XR interaction between users.

### Method for Creating Customized Content Based on User's Physical or Cognitive Abilities

As an example of the present disclosure, a sensor for measuring a user's physical ability may include a sensor worn/mounter on the face and/or a patch-type sensor attached to the body.

For example, face-worn (or head-mounted) sensors may include pupil size measurement sensors, eye trackers, electroencephalographs, gyro sensors worn around the face, etc.

For example, a patch-type sensor attached to the body may be attached to a wrist, arm, shoulder, waist, calf, instep, or foot. A patch-type sensor attached to the body may include a sensor that can be held by hand.

The sensors described above may extract physical quantities such as coordinates, speed, acceleration, and angular velocity for individual user body parts (eyes, joints).

The device may measure the level of physical ability of each user through the physical quantity acquired through the above-described sensor. The device may analyze the characteristics of the user's physical reactions and movements, and physical function features, etc. from the data measuring the level of physical ability of each user.

Accordingly, the device may select an optimal content level or content difficulty level by applying a deep learning technique to content suitable for the characteristics of the user's physical reactions and movements and body function features.

The device may preprocess customized 3D image content before transmitting the selected optimal content level or content difficulty level to the display terminal.

### Hologram Computation Method for Holographic AR/XR Content

The device may calculate/acquire holograms for holographic AR/XR content by applying deep learning techniques.

Additionally or alternatively, the computational method for high-speed hologram generation may include a method of applying a fast-Fourier transform (FFT)-based computer-generated hologram (CGH) calculation formula described below to an RGB depth map as input information.

Specifically, when dividing a three-dimensional space including a 3D scene into multiple layers, it is assumed that the hologram plane (H), the observer's viewing plane (VP), and each layered layer are cut parallel to each other.

Here, point clouds that are distributed almost continuously can be assigned to the nearest layer. The device may perform a discontinuous Fourier transform by using an FFT algorithm to calculate a complex field in the hologram plane.

The calculation formula for performing the Fourier transform may be implemented as in mathematical formulas 1 and 2.

$${U}_{VW} ( u , v ) = {\sum }^{\begin{matrix}i = 1 \\ m\end{matrix}} \frac{{e}^{\frac{π j}{λ {d}_{i}} ( {u}^{2} + {v}^{2} )}}{j λ {d}_{i}} \frac{f}{{d}_{i}} \int \int {U}_{i} ( {x}_{i} , {y}_{i} ) {e}^{\frac{- 2 π j}{λ {d}_{i}} ( {ux}_{i} + {vy}_{i} )} {dx}_{i} {dy}_{i} \qquad [ Equation 1 ]$$

$${U}_{H} ( x , y ) = \frac{j}{λ f} {U}_{VW} ( u , v ) {e}^{- \frac{π j}{λ f} ( {u}^{2} + {v}^{2} )} {e}^{\frac{2 π j}{λ f} ( xu + yv )} dudv \qquad [ Equation 2 ]$$

In Equations 1 and 2, (u, v), (xᵢ, yᵢ), Uᵢ, f, λ and dᵢ may represent the viewer's observation plane, the i^{th} layer of the 3D image, the object or scene field of the i^{th} layer, the focal length of the field lens, the wavelength of the illuminating light, and the viewing distance from the hologram plane, respectively.

The device may spatially restore (or reconstruct) an original 3D scene through depth map-based CGH calculated according to the above-described method, and a user using a face-mounted (or head-mounted) display device can experience a realistic image of an optically restored 3D scene at the eye position.

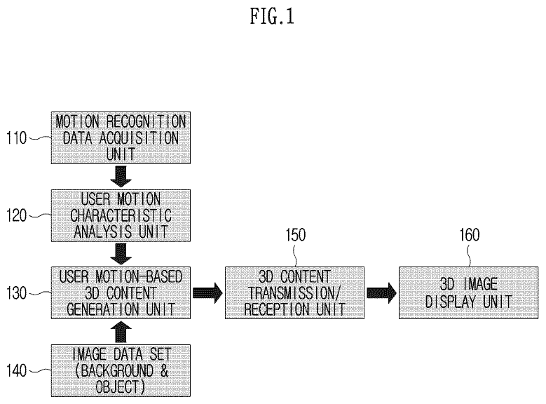

FIG. 1 is a diagram illustrating components and processes for generating and displaying interactive holographic content according to one embodiment of the present disclosure.

The motion recognition data acquisition unit (110) may acquire motion recognition data through one or more sensors (e.g., sensors worn on the face and/or patch-type sensors attached to the body, etc.).

As described above, the face-worn (or head-mounted) sensors may include pupil size measurement sensors, eye trackers, electroencephalographs, gyro sensors worn around the face, and the like.

And, the patch type sensor attached to the body can be attached to the wrist, arm, shoulder, waist, calf, instep, or foot. The patch type sensor attached to the body may include a sensor that can be held by hand, etc.

The above-described sensors may measure motion recognition data including physical quantities such as coordinates, speed, acceleration, and angular velocity for each user's individual body parts (eyes, joints).

The user motion characteristic analysis unit (120) may measure the level of physical ability of each user from physical quantities acquired through one or more sensors. The user motion characteristic analysis unit (120) may analyze the characteristics of the user's physical reaction/motion and physical function features, etc. from data measuring the level of physical ability of each user.

The user motion characteristic analysis unit (120) may select an optimal content level or content difficulty level by applying a deep learning technique to content suitable for the user's physical characteristics. The user motion characteristic analysis unit (120) may preprocess user-customized 3D image content (e.g., holographic AR/XR content) before transmitting it to a display terminal.

The user motion-based 3D content generation unit (130) may generate user motion-based 3D content by using an image data set (e.g., a data set including images of a background or/and an object) and user motion characteristics extracted by the user motion characteristic analysis unit (120) and/or optimal content level/difficulty.

The 3D content transmission/reception unit (150) may transmit and receive one or more 3D contents selected from among the 3D contents generated by the user motion-based 3D content generation unit (130). Here, the one or more 3D contents selected from among the 3D contents can mean 3D contents suitable for the user's left eye and right eye based on the restored spatial location and the arrangement of the optical device.

The 3D image display unit (160) may display 3D content transmitted and received by the 3D content transmission/reception unit (150). The 3D image display unit (160) may restore 3D content in a three-dimensional space.

The user may interact with the 3D content displayed through the 3D image display unit (160) based on gestures, response actions, cognitive functions, etc.

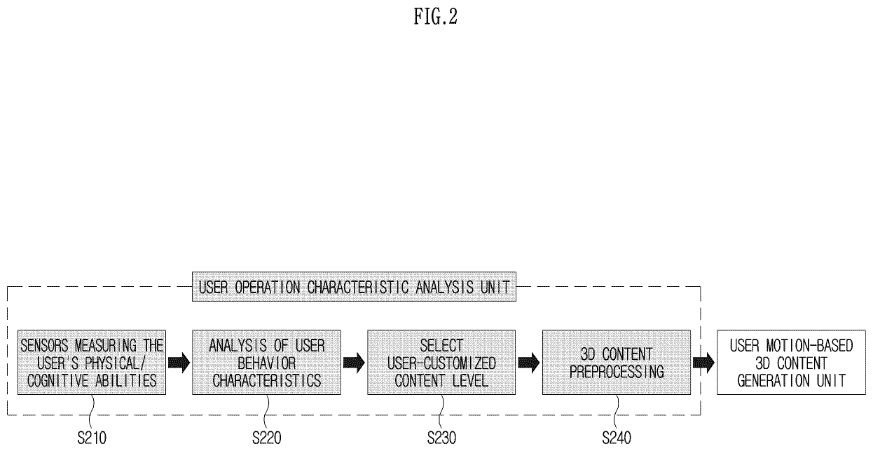

FIG. 2 is a diagram for explaining the operation of a user action specific analysis unit according to one embodiment of the present disclosure.

That is, FIG. 2 is a drawing for explaining the specific operation of the user operation characteristic analysis unit (120) of FIG. 1.

The user motion characteristic analysis unit (120) may obtain various data through sensors measuring the user's physical ability and cognitive ability (S210).

For example, the user motion characteristic analysis unit (120) may extract physical quantities such as coordinates, speed, acceleration, and angular velocity for the user's body parts.

The user motion characteristic analysis unit (120) may analyze the characteristics of the user's movement using various data acquired through the user's physical ability and cognitive ability measurement sensors (S220).

For example, the user motion characteristic analysis unit (120) may measure the level of physical ability of each user from physical quantities acquired through sensors. The user motion characteristic analysis unit (120) may analyze the user's physical response, motion characteristics, and body function features from the measured data.

The user motion characteristic analysis unit (120) may select the optimal content level or/and content difficulty level suitable for the user's physical characteristics by applying deep learning techniques (S230).

The user motion characteristic analysis unit (120) may preprocess (S240) content suitable for the user's physical characteristics according to the optimal content level or/and content difficulty before transmitting the content.

Accordingly, the user motion-based 3D content generation unit (130) may generate user motion-based 3D content using an image data set (e.g., a data set including images of a background or/and an object) and 3D content suitable for the preprocessed body characteristics of the user.

### Deep Learning Model for Re-View Image Generation for Holographic AR/XR

Hereinafter, a deep learning model that generates re-view images for holographic AR/XR is described in detail.

In the present disclosure, the Monochromatic-Holographic Dense Depth (MHDD) model is described as a deep learning model for re-view image generation for holographic AR/XR.

The decoder of the MHDD model may connect the feature maps of the shallow layer and the feature maps of the deep layer through a skip connection procedure, and may expand the size of the previously reduced feature map again through an upsampling layer.

The output layer of the MHDD model may output a single depth map image estimated to have the same size as the input color image through a bilinear interpolation process.

Specifically, the MHDD model may be trained by reducing the quality difference between the estimated depth map image and the ground truth depth map image using a loss function.

Here, for learning the MHHD model, the loss function may be composed of a combination of structural similarity index (SSIM) and mean square error (MSE), and can be composed as in mathematical expression 3.

$$Loss function = ( α ) \times MSE + ( 1 - α ) \times SSIM \qquad [ Equation 3 ]$$

Here, the optimal ratio α may be experimentally determined by setting the loss function most suitable for learning. As an example, by using a test dataset consisting of 1,640 depth map images, the overall average value of the PSNR (peak signal-to-noise ratio) measured from the estimated depth map of the MHHD model and the ground truth depth map was calculated.

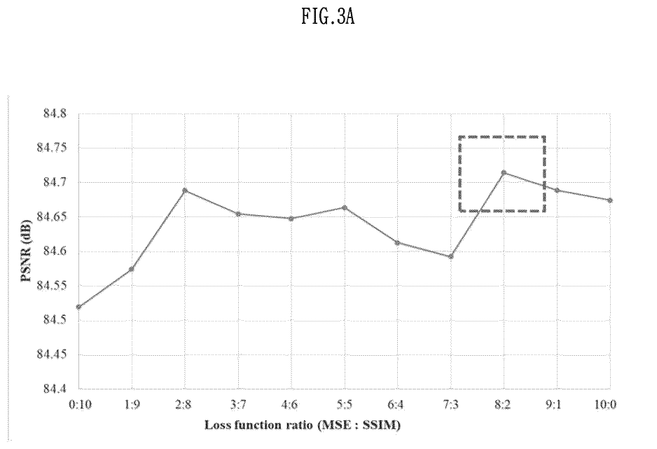

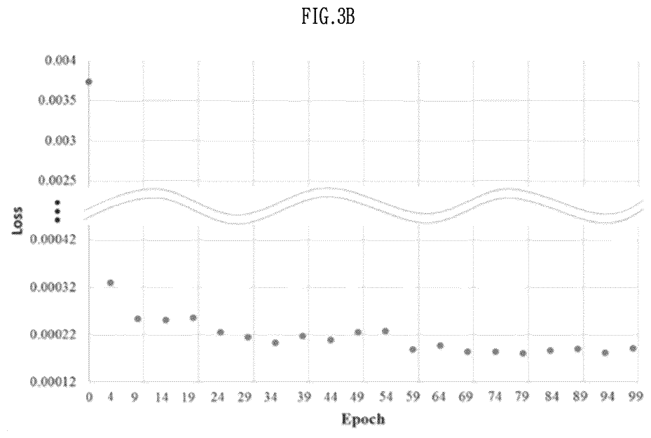

FIG. 3A and FIG. 3B illustrate measurement results of PSNR from the learning process of the MHHD model described above. For example, FIG. 3A shows PSNR characteristics according to the MSE:SSIM ratio in the learning process of the deep learning MHDD model. FIG. 3B shows the change trend of the loss function for epochs in the training process of the MHDD model.

The loss function and evaluation index will be described later. First, the performance index for measuring the quality of the depth map image estimated from the MHDD model and the original depth map image may be calculated using mathematical expression 4.

$$MSE = \frac{1}{n} {\sum }_{i = 1}^{n} {( {y}_{i} - {y}_{i}^{′} )}^{2} \qquad [ Equation 4 ]$$

The MSE of Equation 4 may be used to measure the difference in pixel values of two images. In Equation 4, yᵢ represents a pixel of the original depth map image, and yᵢ′ represents a pixel of the estimated depth map image. The more similar the original depth map image and the depth map image are, the lower the MSE value of Equation 4 can be.

In addition, PSNR may be used to evaluate the damage information of two images (i.e., the original depth map image and the estimated depth map image), and may be configured as Equation 5.

$$PSNR = 10 log \frac{{s}^{2}}{MSE} \qquad [ Equation 5 ]$$

In Equation 5, s corresponds to the maximum value of a pixel in the image, and the depth map image in 8-bit grayscale format has a value of 255. PSNR can have an inverse relationship with MSE. As the two images (i.e., the original depth map image and the estimated depth map image) are more similar to each other, the PSNR value can increase.

SSIM may be used to evaluate quality by comparing the overall brightness, contrast, and structural information of an image and the similarity between the original image and the estimated depth map image. SSIM may be calculated according to the Equation 6.

$$SSIM = \frac{( 2 {μ}_{y} {μ}_{{y}^{′}} + {C}_{1} ) ( 2 {σ}_{{yy}^{′}} + {C}_{2} )}{( 2 {μ}_{y}^{2} + {μ}_{{y}^{′}}^{2} + {C}_{1} ) ( {σ}_{y}^{2} + {σ}_{{y}^{′}}^{2} + {C}_{2} )} \qquad [ Equation 6 ]$$

In Equation 6, μ_{y} and μ_{y′} represent the average for each of the two images (i.e., the original depth map image and the estimated depth map image). σ_{y}² and σ_{y′}² represent the text products of each of the two images. σ_{yy′} may mean the covariance corresponding to brightness, contrast, and correlation information.

SSIM has a value between [0, 1] and evaluates the similarity between two images using attribute information such as brightness, contrast, and structure. The closer the SSIM value is to 1, the more similarity between the two images can increase.

Based on the above-mentioned performance metrics (e.g., PSNR, MSE and SSIM) that are mainly used for image quality measurement, the loss function used for training the MHDD model may be connected in an additive form.

In Equation 3, α corresponds to the ratio between two indices (MSE and SSIM) and may have a value between 0≤α≤1.

In the present disclosure, a loss function for learning an MHDD model can be configured by determining an α ratio that can optimize the performance of the model.

As an example of the present disclosure, as shown in FIG. 3A, the optimal a value may be 0.8. Table 1 shows the performance measurement results of the MHDD model for various 3D shapes (e.g., cone, cube, sphere, and torus) through the MHDD model.

TABLE 1

| | Indicator | | |
|---|---|---|---|
| Shape | SSIM | PSNR | RMSE |
| Cone | 0.9999 | 84.52 | 0.0006 |
| Cube | 0.9999 | 84.39 | 0.0003 |
| Sphere | 0.9999 | 85.03 | 0.0002 |
| Torus | 0.9999 | 84.90 | 0.0003 |

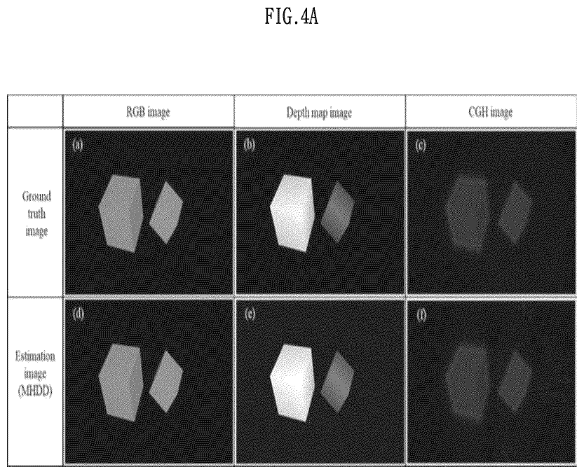

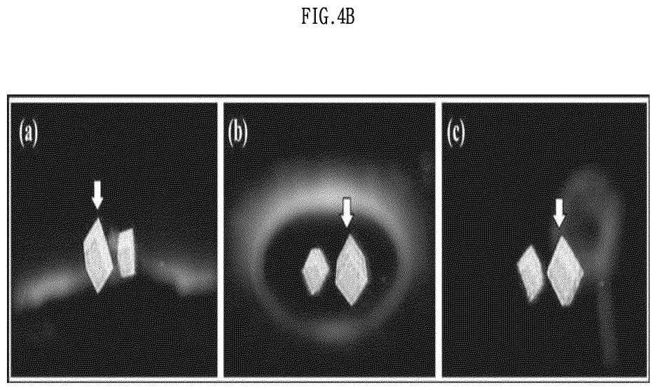

As an example of the present disclosure, FIGS. 4A and 4B illustrate examples of color images, depth maps, and holograms generated using them. That is, FIGS. 4A and 4B illustrate examples of implementing hyper-realistic stereoscopic video scenes on an HMD type display system using 3D objects of multiple RGB colors and various background images.

Here, the arrows in FIG. 4B indicate objects focused on by the user's eyes among the objects restored in real space.

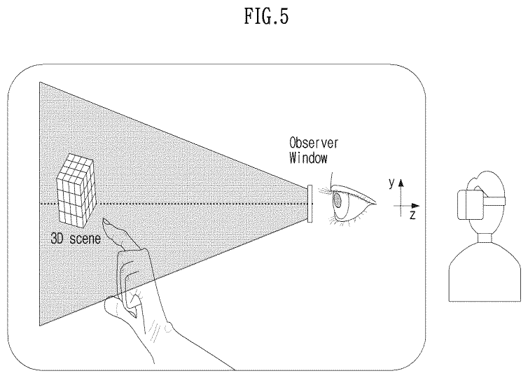

As an example of the present disclosure, FIG. 5 is a drawing for explaining a process in which a user wearing an XR device interacts with a 3D object.

Specifically, FIG. 5 illustrates a real-time interaction between a wearer of an XR device and a holographic AR/XR image played in a hyper-realistic space, i.e., a 3D object, by directly touching, manipulating the size and direction of the object with the user's hand.

In particular, in the present disclosure, physical quantities such as coordinates, speed, velocity, and angular velocity for each body part of a user may be extracted from various sensors attached to the user's body.

From the physical quantities acquired through each sensor, the level of physical ability of each user is measured, and the user's physical response, movement characteristics, and features associated with body functions may be analyzed from the measurement data.

In the present disclosure, a deep learning technique may be applied to content suitable for a user's physical characteristics based on the analysis results, so that an optimal content level or content difficulty level may be selected. Content according to the selected optimal content level or content difficulty can be output on a display terminal.

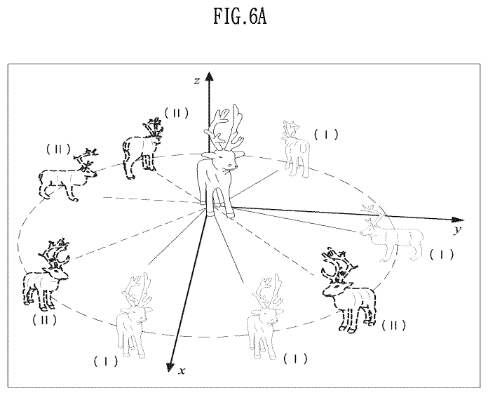

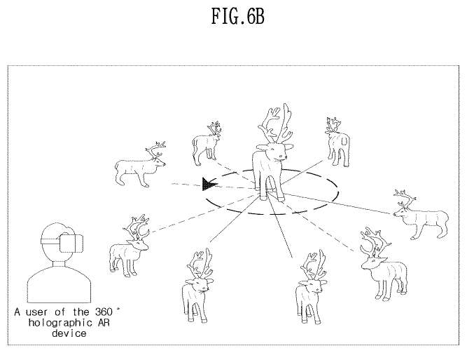

As an example of the present disclosure, FIG. 6A illustrates a process of high-speed generation/processing of images of various viewpoints or images in between viewpoints by applying a deep learning model. And FIG. 6B illustrates a process of enabling real-time interaction between a wearer of an XR device and a reproduced holographic AR/XR image.

According to the various examples described above of the present disclosure, the limitations centered on manual holographic content creation by conventional computer hologram generation can be overcome. In addition, according to the various examples described above of the present disclosure, it is possible to escape from the complex devices and long-time content calculation processes for creating conventional holograms.

Accordingly, users can enjoy various types of holographic AR content as well as stereoscopic 3D-based XR content, and actively interact with 3D image content.

In addition, the present disclosure enables users to experience the ultimate realistic images. As described above, the device according to the present disclosure can measure the level of physical ability of each user, and analyze the characteristics of the user's physical reactions and movements, and physical function features from the measurement data. In addition, the device can select the optimal content level or content difficulty level by applying a deep learning technique to content suitable for the analysis result.

Therefore, the present disclosure can be used as a basic technology for creating customized content considering the physical characteristics of the user, and can enable high-speed AI-linked image processing. The present disclosure can be suitable for personal portable or face-worn mobile devices.

Various embodiments of the present disclosure provide users with comfortable immersive and 3D realism effects, and in particular, can be controlled to enable real-time experiences through interaction between the user and the restored 3D realism image.

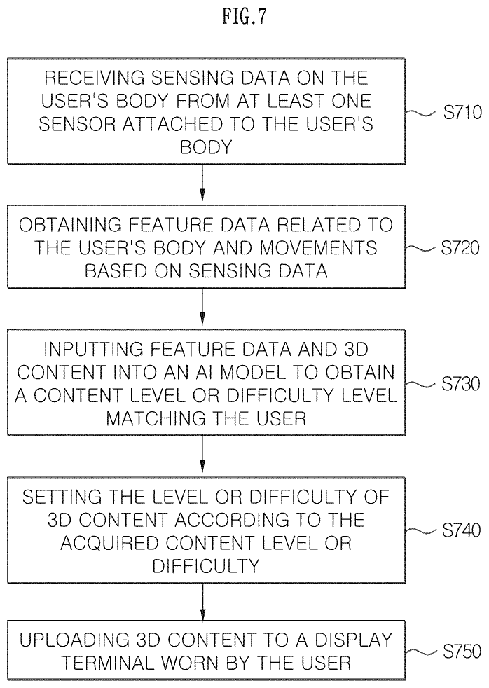

FIG. 7 is a flowchart illustrating a method of generating and displaying interactive holographic content according to one embodiment of the present disclosure.

In FIG. 7, the device may be composed of various types of electronic devices. As an example of the present disclosure, the device may be mounted or built into a display terminal, but is not limited thereto, and may also be provided outside the display terminal.

The device may receive sensing data on the user's body from at least one sensor attached to the user's body (S710).

Specifically, each body part of the user may be equipped with at least one sensor capable of sensing various physical quantities (e.g., at least one of coordinates, speed, acceleration, or angular velocity) on the body part of the user. The device may obtain at least one of coordinates, speed, acceleration, or angular velocity of the body part of the user through the at least one sensor.

Here, the device may be wirelessly connected to at least one sensor, but may also be electrically connected.

The device may obtain feature data related to the user's body and movements based on sensing data (S720).

Specifically, the device may obtain feature data including the user's physical ability level and the characteristics of the user's movements through at least one of coordinates, velocity, acceleration, or angular velocity of a body part of the user.

For example, the device may output feature data including characteristics of the user's physical ability level and the user's movements based on coordinates, velocity, acceleration, and/or rate or magnitude of change of angular velocity for body parts.

The device may input feature data and 3D (dimension) content into an artificial intelligence (AI) model (e.g., a first AI model) to obtain a content level or difficulty level matching the user (S730).

Specifically, the device may generate 3D content (e.g., hologram-based content) based on a color image and a depth map for at least one object.

The device may acquire a color image and a depth map for one object. The device may generate 3D data for at least one object based on each of the color images and the depth map. Here, a pair of color images and depth maps of a specific object means data corresponding to one view. The 3D content may be composed of one or more views.

Additionally, the device may preprocess 3D data for at least one object.

As an example, the device may select a specific image region from the 3D data (e.g., a desired image region for display via a display terminal) and remove the remaining region. As another example, the device may remove noise on the 3D data.

Specifically, the device may modify the orientation, position, features, etc. of the image of the object in a selected specific image area. The device may store the preprocessed 3D data in the form of a color image-depth map in a specific format or by viewpoint.

The device may generate at least one hologram data (e.g., a computer-generating hologram (CGH)) using 3D data for at least one preprocessed object.

For example, the device may obtain at least one hologram data by inputting data stored in the form of a color image-depth map (i.e., 3D data for at least one preprocessed object) into a separate AI model (e.g., a second AI model). As another example, the device may obtain at least one hologram data by applying a hologram generation algorithm to the data stored in the form of a color image-depth map.

The device may correct at least one holographic data based on information about the display terminal.

Here, information about the display terminal may include the size of the display terminal, the performance of the display terminal, the type of an operating device connected to the display terminal, and the type of the display terminal.

Here, the display terminal may include, but is not limited to, a head mounted display.

And, at least one manipulation device may include a wearable device capable of interacting with at least one holographic data included in the 3D content.

The device may determine/correct the size and arrangement of at least one hologram data based on the size of the display terminal, the performance of the display terminal, the type of at least one operating device connected to the display terminal, and the type of the display terminal.

For example, if the size of the display terminal is small, the device can reduce the size of at least one hologram data and adjust its arrangement.

Meanwhile, the first AI model may be trained to output a content level or difficulty level that matches the user based on at least one piece of calibrated hologram data, the user's physical ability level, and the characteristics of the user's movements.

That is, the first AI model may be trained to output a content level or difficulty level that matches the user through i) features of at least one hologram data that constitutes the 3D content and ii) features of the user's physical ability level and the user's movements.

The device may set the level or difficulty of 3D content according to the acquired content level or difficulty (S740).

That is, the device may select a content level or content difficulty level of 3D content suitable for the user's physical characteristics. The device may post-process or pre-process 3D content for which the content level/difficulty level is set.

Here, the interaction required to enjoy/experience 3D content may vary depending on the content level or content difficulty of the 3D content. For example, if the level/difficulty of the 3D content is set to “high”, the level/difficulty of the interaction required to solve missions, etc. on the 3D content may be set to increase.

The device may upload 3D content to a display terminal worn by the user (S750).

A plurality of hologram pairs included in 3D content may include hologram data suitable for the left and right eyes of the viewer respectively based on the positions in 3D space restored by the display terminal and the arrangement of the optical device.

When 3D content is uploaded by the device, the display terminal may restore a holographic image on the 3D content into a three-dimensional space by illuminating it with a specific light.

The display terminal may include an optical device that provides coherent light capable of uniformly illuminating an active area of a spatial light modulator (SLM).

The display terminal may be controlled to interact with holographic data on 3D content based on the user's gestures, response actions, cognitive functions, etc. For example, the display terminal may apply a user command input through at least one operating device to the 3D content.

That is, a user can interact with holographic data on 3D content using one or more operating devices or gestures while wearing a display terminal.

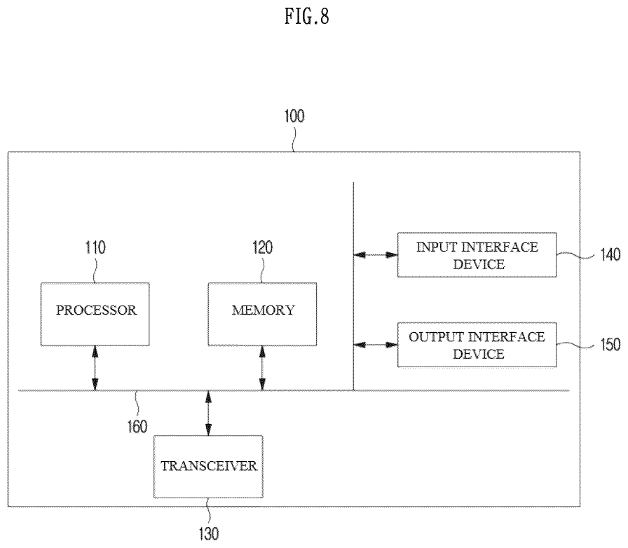

FIG. 8 is a block diagram illustrating a device according to an embodiment of the present disclosure.

Referring to FIG. 8, the device (100) may provide a method for processing and displaying hyper-realistic image content and stereoscopic images that enable XR interaction between users. The device (100) may be mounted on a display terminal, but is not limited thereto, and may also be placed outside the display terminal.

For example, the device (100) may generate 3D content based on a color image-depth map for an object. The device (100) may set the difficulty and level of the 3D content based on the user's body/motion-related feature data. The device may upload the 3D content with the set difficulty and level to a display terminal.

The device (100) may include at least one of a processor (110), a memory (120), a transceiver (130), an input interface device (140), and an output interface device (150). Each of the components may be connected to each other by a common bus (160). In addition, each of the components may be connected to each other through an individual interface or individual bus centered on the processor (110), rather than the common bus (160).

The processor (110) may be implemented in various types such as an AP (Application Processor), a CPU (Central Processing Unit), a GPU (Graphic Processing Unit), etc., and may be any semiconductor device that executes a command stored in the memory (120). The processor (110) may execute a program command stored in the memory (120). The processor (110) may perform a method of processing and displaying a hyper-realistic image content and a stereoscopic image that enables XR interaction between users based on the above-described FIGS. 1 to 7.

The processor (110) may control the overall operation and function of the device (100).

And/or, the processor (110) may store program instructions for implementing at least one function for one or more modules in the memory (120) so as to control the operations described based on FIGS. 1 to 7 to be performed. That is, each operation and/or function according to FIGS. 1 to 7 may be executed by one or more processors (110).

The memory (120) may include various forms of volatile or non-volatile storage media. For example, the memory (120) may include read-only memory (ROM) and random access memory (RAM). In an embodiment of the present disclosure, the memory (120) may be located inside or outside the processor (110), and the memory (120) may be connected to the processor (110) through various means already known.

For example, the memory (120) may obtain the user's body sensing data, feature data, 3D content, etc.

The transceiver (130) may perform a function of transmitting and receiving data processed/to be processed by the processor (110) with an external device and/or an external system.

For example, the transceiver (130) may be utilized for data exchange with other terminal devices, etc.

The input interface device (140) may be configured to provide data to the processor (110).

The output interface device (150) may be configured to output data from the processor (110).

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that this disclosure include all other substitutions, modifications and variations falling within the scope of the following claims.

What is claimed is:

1. A method of generating and displaying interactive 3D content performed by a device, the method comprising:
receiving sensing data on a user's body from at least one sensor attached to the user's body;
obtaining feature data related to the user's body and movement based on the sensing data;
obtaining a content level or difficulty matching the user by inputting feature data and 3D (dimension) content into an artificial intelligence (AI) model;
setting a level or difficulty of the 3D content according to the obtained content level or difficulty; and
uploading the 3D content to a display terminal worn by the user.

2. The method of claim 1, wherein:
the sensing data includes at least one of coordinates, velocity, acceleration, or angular velocity of a body part of the user, and
the obtaining the feature data comprises:
obtaining characteristic data including a level of physical ability of the user and a characteristics of the user's movement through at least one of the coordinates, velocity, acceleration, or angular velocity of a body part of the user.

3. The method of claim 2, further comprising:
obtaining a color image and a depth map for at least one object; and
generating 3D data for the at least one object based on each of the color images and the depth map.

4. The method of claim 3, further comprising:
preprocessing 3D data for at least one object;
generating at least one hologram data using the preprocessed 3D data for at least one object; and
correcting the at least one hologram data based on information on the display terminal.

5. The method of claim 4, further comprising:
the information on the display terminal includes a size of the display terminal, a performance of the display terminal, a type of an operating device connected to the display terminal, and a type of the display terminal, and
a size and arrangement of the at least one hologram data are corrected based on the size of said display terminal, the performance of the display terminal, the type of at least one operating device connected to the display terminal, and the type of the display terminal.

6. The method of claim 5, wherein:
the AI model is trained to output a content level or difficulty level that matches the user based on at least one of the corrected hologram data, the level of physical ability of the user, and the characteristics of the user's movements.

7. The method of claim 5, wherein:
the display terminal comprises a head mounted display, and
the at least one operating device comprises a wearable device capable of interacting with the at least one hologram data included in the 3D content.

8. A device of generating and displaying interactive 3D content, the device comprising:
at least one memory; and
at least one processor,
wherein the at least one processor is configured to:
receive sensing data on a user's body from at least one sensor attached to the user's body;
obtain feature data related to the user's body and movement based on the sensing data;
obtain a content level or difficulty matching the user by inputting feature data and 3D (dimension) content into an artificial intelligence (AI) model;
set a level or difficulty of the 3D content according to the obtained content level or difficulty; and
upload the 3D content to a display terminal worn by the user.

9. The device of claim 8, wherein:
the sensing data includes at least one of coordinates, velocity, acceleration, or angular velocity of a body part of the user, and
the at least one processor is configured to:
obtain characteristic data including a level of physical ability of the user and a characteristics of the user's movement through at least one of the coordinates, velocity, acceleration, or angular velocity of a body part of the user.

10. The device of claim 9, wherein:
the at least one processor is configured to:
obtain a color image and a depth map for at least one object; and
generate 3D data for the at least one object based on each of the color images and the depth map.

11. The device of claim 10, wherein:
the at least one processor is configured to:
preprocess 3D data for at least one object;
generate at least one hologram data using the preprocessed 3D data for at least one object; and
correct the at least one hologram data based on information on the display terminal.

12. The device of claim 11, wherein:
the information on the display terminal includes a size of the display terminal, a performance of the display terminal, a type of an operating device connected to the display terminal, and a type of the display terminal, and
a size and arrangement of the at least one hologram data are corrected based on the size of said display terminal, the performance of the display terminal, the type of at least one operating device connected to the display terminal, and the type of the display terminal.

13. The device of claim 12, wherein:
the AI model is trained to output a content level or difficulty level that matches the user based on at least one of the corrected hologram data, the level of physical ability of the user, and the characteristics of the user's movements.

14. The device of claim 11, wherein:
the display terminal comprises a head mounted display, and
the at least one operating device comprises a wearable device capable of interacting with the at least one hologram data included in the 3D content.

15. A system for creating and displaying interactive 3D content, the system comprising:
a device; and
a display terminal,
wherein the device is configured to:
receive sensing data on a user's body from at least one sensor attached to the user's body;
obtain feature data related to the user's body and movement based on the sensing data;
obtain a content level or difficulty matching the user by inputting feature data and 3D (dimension) content into an artificial intelligence (AI) model;
set a level or difficulty of the 3D content according to the obtained content level or difficulty; and
upload the 3D content to a display terminal worn by the user, and
wherein the display terminal is configured to:
display the 3D content in a 3D space; and
apply a user command input through at least one operating device to the 3D content.
